(19) United States
(12) Patent Application Publication
(10) Pub. No.: US 2009/0134808 A1
(43) Pub. Date: May 28, 2009

(54) Discharge Tube Array and Display Device Using Same

(75) Inventors: Koji Shinohe, Hyogo (JP); Manabu Ishimoto, Hyogo (JP); Kenji Awamoto, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: Shinoda Plasma Corporation, Kobe-shi (JP)

(21) Appl. No.: 11/922,360

(22) PCT Filed: Jun. 17, 2005
(86) PCT No.: PCT/JP2005/011128

§ 371 Date: Dec. 17, 2007

(51) Int. Cl. G09G 3/10; H01J 61/02

(52) U.S. Cl. 315/169.1; 313/1

(57) ABSTRACT

A discharge tube array includes a plurality of narrow discharge tubes (10) each provided with an internal fluorescent layer (13). The array also includes a holder (20) formed with a hollow portion (21) for holding the discharge tubes (10) in a mutually parallel state, where the discharge tubes (10) are removably inserted into the hollow portion (21). The holder (20) is provided with a plurality of first electrodes (23) disposed along the discharge tubes (10), and with a plurality of second electrodes (24A, 24B) opposing the first electrodes (23) across the hollow portion (21) and extending in a direction intersecting with the first electrodes (23).

### TECHNICAL FIELD

The present invention relates to a discharge tube array for use in a flat display panel for example, and also to a display device utilizing the discharge tube array.

### BACKGROUND ART

An example of conventional discharge tube array is disclosed in Patent document 1 cited below. The discharge tube array has a laminate structure including a plurality of discharge tubes arranged in parallel between a transparent substrate on a front side and a substrate on a back side, where the substrates and the discharge tubes are bonded by e.g. an adhesive. Each of the discharge tubes is, for example, 2 mm or less in diameter and 300 mm or more in length, and includes an internal fluorescent layer. On the inner surface of the front-side substrate, display electrodes are provided so as to intersect with the discharge tubes in contact therewith, while on the inner surface of the back-side substrate, address electrodes are provided along the respective discharge tubes in contact therewith. Each portion where one discharge tube intersects with one display electrode constitutes a minimum unit portion for light emission. All the light emitting unit portions are selectively driven to emit light instantaneously so that a two-dimensional display image is produced.

Patent document 1: JP-A-2003-86142

In the conventional discharge tube array, however, the substrates and the discharge tubes are firmly bonded to each other. Thus, even when one light emitting unit portion of the discharge tube is broken due to e.g. deterioration with time, not only the defective discharge tube but also the other discharge tubes and the substrates, which are quite normal in function, need to be replaced. Further, it is not an easy job to replace the conventional discharge tubes because each discharge tube has to be accurately positioned with respect to the address-electrode provided on the back-side substrate.

### DISCLOSURE OF THE INVENTION

The present invention has been proposed under the above-described circumstances. An object of the present invention is to provide a discharge tube array that permits easy replacement of the discharge tubes, while also providing a display device that includes such a discharge tube array.

To achieve the foregoing object, the present invention adopts the following technical measures.

A first aspect of the present invention provides a discharge tube array including a plurality of narrow discharge tubes each provided with an internal fluorescent layer. The array also includes a holder formed with a hollow portion for holding the discharge tubes in a mutually parallel state, where the discharge tubes are removably inserted into the hollow portion.

Preferably, the hollow portion may include a partition wall for dividing the discharge tubes into groups of a predetermined number.

Preferably, the hollow portion may include a corrugated plate-shaped auxiliary member for positioning the discharge tubes at a predetermined interval.

Preferably, the hollow portion may be loaded with a liquid dielectric filling in a gap around the discharge tubes.

Preferably, the holder may be separable into elements each for accommodating a predetermined unit number of the discharge tubes.

Preferably, the holder may be provided with a plurality of first electrodes disposed along the discharge tubes, and with a plurality of second electrodes opposing the first electrodes across the hollow portion and extending in a direction intersecting with the first electrodes.

Preferably, the holder may have a laminate structure including a first member having the first electrodes and a second member having the second electrodes.

A second aspect of the present invention provides a display device that incorporates a discharge tube array provided with a plurality of narrow discharge tubes each including an internal fluorescent layer. The display device comprises: a hollow portion for holding the discharge tubes in a mutually parallel state; a plurality of first electrodes disposed along the discharge tubes; a plurality of second electrodes opposing the first electrodes across the hollow portion and extending in a direction intersecting with the first electrodes; and a holder for removably holding the discharge tubes in the hollow portion. The display device further comprises a first driving circuit for applying voltage to the first electrode; and a second driving circuit for applying voltage to the second electrode.

### BRIEF DESCRIPTION OF THE DRAWINGS

FIG. 1 is a perspective view showing the overall structure of a discharge tube array according to a first embodiment of the present invention;

FIG. 2 is a fragmentary cross-sectional view of the discharge tube array shown in FIG. 1;

FIG. 3 is a fragmentary cross-sectional view of a discharge tube array according to a second embodiment of the present invention;

FIG. 4 is a fragmentary cross-sectional view of a discharge tube array according to a third embodiment of the present invention;

FIG. 5 is a fragmentary cross-sectional view of a discharge tube array according to a fourth embodiment of the present invention;

FIG. 6 is a fragmentary cross-sectional view of a discharge tube array according to a fifth embodiment of the present invention;

FIG. 7 is a fragmentary cross-sectional view of a discharge tube array according to a sixth embodiment of the present invention;

FIG. 8 is a fragmentary cross-sectional view of a discharge tube array according to a seventh embodiment of the present invention;

FIG. 9 is a fragmentary cross-sectional view of a discharge tube array according to an eighth embodiment of the present invention;

FIG. 10 is a fragmentary cross-sectional view of a discharge tube array according to a ninth embodiment of the present invention;

FIG. 11 is a fragmentary cross-sectional view of a discharge tube array according to a tenth embodiment of the present invention; and

FIG. 12 is a front view showing a display device including a discharge tube array according to an eleventh embodiment of the present invention.

### BEST MODE FOR CARRYING OUT THE INVENTION

Preferred embodiments of the present invention will be described below with reference to the drawings.

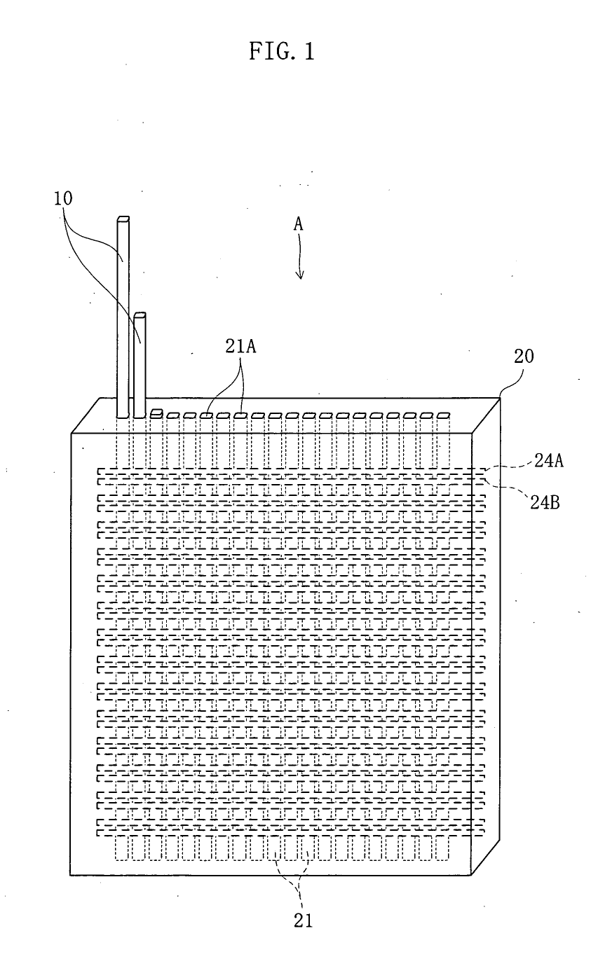

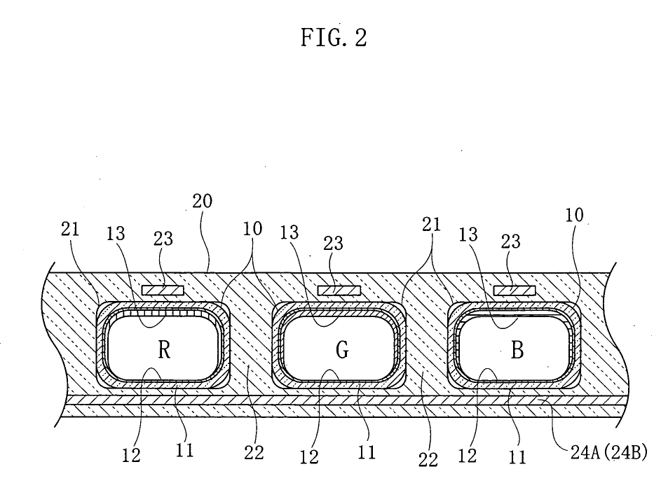

FIGS. 1 and 2 depict a discharge tube array according to a first embodiment of the present invention. As shown in these figures, the discharge tube array A includes a plurality of discharge tubes 10, and a holder 20 into which the discharge tubes 10 can be removably inserted. The discharge tube array A is used to provide a flat display panel.

Referring to FIG. 2, each discharge tube 10 comprises a narrow glass tube 11 which may have a generally elliptical cross-section. The glass tube 11, approximately 1000 mm in length, has a major axis whose length is approximately 1 mm, and a minor axis whose length is approximately 0.75 mm. On the inner wall surface of the glass tube 11, a MgO layer 12 is uniformly provided for protection of the glass, and on a back side of the inner wall surface of the glass tube 11, a fluorescent layer 13 is provided on the surface of the MgO layer 12. The fluorescent layer 13 is constituted of one of R (red), G (green), and B (blue) fluorescent materials, which constitute the three primary colors of light. Inside the glass tube 11 a discharge gas (for example, a mixed gas of Ne and Xe) is enclosed, and the both end portions of the glass tube 11 are air-tightly closed. In the discharge tube 10 thus configured, once voltage is applied from outside, the discharge gas of the corresponding position locally discharges, and a vacuum ultraviolet ray thereby generated excites the fluorescent layer 13, so that the fluorescent layer 13 emits visible light of RGB.

As shown in FIG. 2, the holder 20 is formed of a transparent resin in a plate shape, and includes hollow portions 21 that allow disposing a multitude of discharge tubes 10 in parallel. The hollow portion 21 has an inner diameter that secures a certain gap when inserting or removing the discharge tube 10. Between the adjacent hollow portions 21, a partition wall 22 is provided so as to isolate each of the discharge tubes 10. The hollow portions 21 are aligned at regular intervals via the partition wall 22. At least an end portion of the hollow portion 21 is an open end 21A (Ref. FIG. 1), and those open ends 21A are covered with a cover member (not shown) removably attached to the holder 20.

On the back side of the holder 20, a plurality of address electrodes (first electrode) 23 is buried closely along the respective hollow portions 21, and on the front side of the holder 20, a plurality of display electrode pairs (second electrode) 24A, 24B is buried so as to intersect with the address electrodes 23, on the opposite side of the hollow portion 21. The display electrode pair includes a hold electrode 24A that maintains light emission and a scan electrode 24B that selects a light-emitting cell (light emitting unit portion). The address electrode 23 and the display electrode pair 24A, 24B are connected to a driving circuit provided outside these drawings. Here, the address electrode and the display electrode pair may be formed so as to be exposed on the inner wall surface of the hollow portion.

In the hollow portion 21 of the holder 20, the discharge tubes 10 are inserted and fixed in the sequence of RGB. Each discharge tube 10 is oriented such that the fluorescent layer 13 faces the back side of the holder 20. A portion of the discharge tube 10 corresponding to intersections with the display electrode pair 24A, 24B when inserted into the hollow portion 21 constitutes a light emitting unit portion, and the light emitting unit portions of the three colors RGB constitute a pixel. To display an image, voltage is applied to the scan electrode 24B and the address electrode 23 corresponding to the light emitting unit portion that is the object of light emission, so as to store a charge in the light emitting unit portion. Then voltage is applied to the hold electrode 24A and the scan electrode 24B, so as to cause the light emitting unit portions along the display electrode pair 24A, 24B to glow-discharge. At this stage, controlling the number of pulse of the voltage to be applied for each light emitting unit portion enables gradational expression of the three colors RGB. Such glow-discharge is repeated at extremely short intervals, for example by line sequential scanning, and thereby an image is displayed on the front face of the holder 20.

During the manufacturing process or actual use of the discharge tube array A, a portion of the discharge tube 10, which serves as a light emitting unit portion, may become damaged because of a manufacturing defect or time-dependent deterioration. Otherwise, a row of light emitting region extending longitudinally of the discharge tube 10 may become defective owing to a crack in the glass tube 11. In such case, it is reasonable to pull out a single discharge tube 10 that is damaged from the hollow portion 21 of the holder 20, and to insert a new discharge tube 10 into the hollow portion 21 for replacement.

In doing so, since the holder 20 includes the address electrode 23 along the hollow portion 21, simply inserting the new discharge tube 10 into the hollow portion 21 completes the correct positioning of the discharge tube 10 along the address electrode 23.

With the discharge tube array A according to this embodiment, therefore, in case a portion of the discharge tube 10 is defective it suffices to remove only the defective discharge tube 10 and insert a new one for replacement, and besides in such replacement step, simply inserting the new discharge tube 10 into the hollow portion 21 completes the correct positioning of the discharge tube 10 with respect to the address electrode 23, thus facilitating the replacement work of the discharge tube 10.

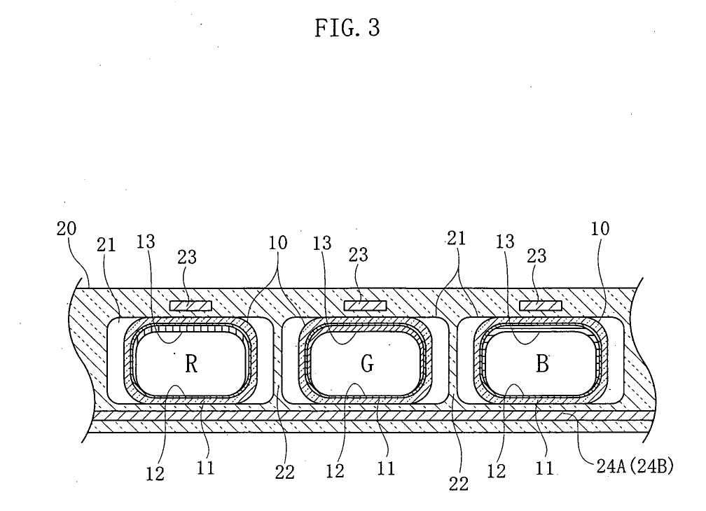

FIGS. 3 through 11 depict other embodiments of the discharge tube array according to the present invention. The same or similar constituents in different embodiments are given the identical numerals, and the description thereof will not be repeated.

FIG. 3 is a fragmentary cross-sectional view of a discharge tube array according to a second embodiment. In the second embodiment, the hollow portion 21 is formed so as to define a larger gap with respect to the discharge tube 10 in a direction of the major diameter thereof, so that the partition wall 22 is made thinner by the same amount. The discharge tube 10 still generally opposes the address electrode 23, though located at a rather biased position in the hollow portion 21. Such discharge tube array allows smoothly removing and inserting the discharge tube 10 from and into the hollow portion 21, since the hollow portion 21 has a sufficiently larger inner diameter than the major diameter of the discharge tube 10.

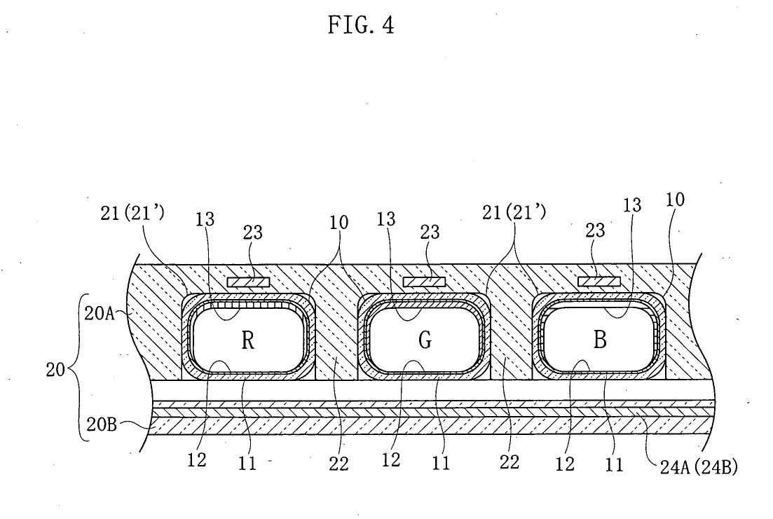

FIG. 4 is a fragmentary cross-sectional view of a discharge tube array according to a third embodiment. In the third embodiment, a first member 20A including the address electrode 23 on a back side thereof and a second member 20B including the display electrode pair 24A, 24B are employed, such that the first member 20A and the second member 20B are stacked and unified, to thus constitute the holder 20. The hollow portions 21 are defined by covering a multitude of recessed portions 21′ provided in a form of recessed grooves on a side of the first member 20A, with the second member 20B. The depth of the recessed portion 21′ is close to the minor diameter of the discharge tube 10. In the manufacturing process, for example, the discharge tubes 10 may be placed in the recessed portions 21′ of the first member 20A, and then the second member 20B and portions corresponding to the partition walls 22 may be fusion-bonded. After the manufacturing, the discharge tube 10 can be removed and inserted, longitudinally of the hollow portion 21. Such discharge tube array allows distributing the discharge tubes 10 in the respective recessed portions 21′, which are to constitute the hollow portions 21, during the manufacturing process, thus simplifying the manufacturing process of the discharge tube array.

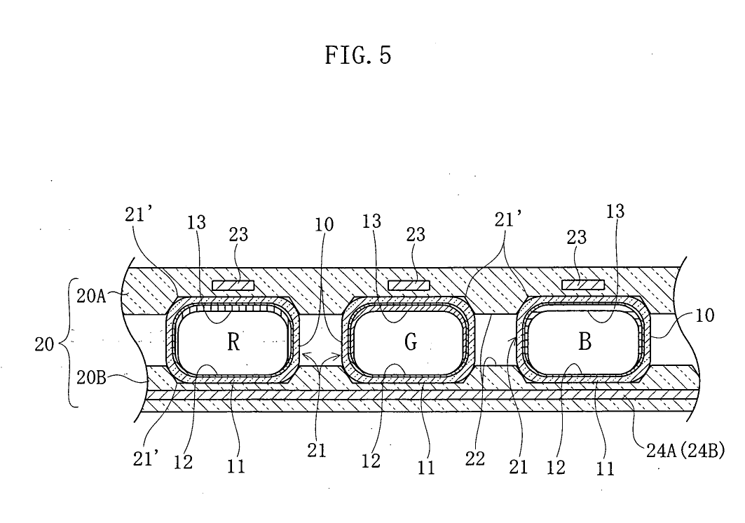

FIG. 5 is a fragmentary cross-sectional view of a discharge tube array according to a fourth embodiment. In the fourth embodiment also, the first member 20A and the second member 20B are employed. The first member 20A and the second member 20B are joined at the respective end portions excluded from the drawing by fusion-bonding or via a spacer, thereby constituting the holder 20. The first member 20A includes on a side thereof a multitude of recessed portions 21′ formed with a taper in a recessed groove shape, and the second member 20B also includes on a side thereof similar recessed portions 21′. The hollow portion 21 is defined by stacking the first member 20A and the second member 20B, with the respective recessed portions 21′ oriented to oppose each other. The depth of the recessed portion 21′ is shallower than the minor diameter of the discharge tube 10. Accordingly, the partition wall 22 does not completely isolate the adjacent hollow portions 21, but allowing communication between the adjacent hollow portions 21. Such partition wall 22 serves as a stopper that prevents positional shift of the discharge tube 10. In the manufacturing process, for example the discharge tubes 10 may be distributed in the recessed portions 21′ of the first member 20A, and then the recessed portions 21′ of the second member 20B may be stacked on the discharge tubes 10 arranged in place. After that, the respective end portions of the first member 20A and the second member 20B may be joined by fusion-bonding or via a spacer. Naturally, after the manufacturing the discharge tube 10 can be removed and inserted longitudinally of the hollow portion 21. Such discharge tube array enables smoothly aligning the discharge tubes 10 with respect to the recessed portions 21′ in the manufacturing process, without strictly controlling the positioning accuracy of the discharge tubes 10 with respect to the recessed portions 21′. Here, it suffices that a total amount of the depth of the recessed portion 21′ of the first member 20A and that of the recessed portion 21′ of the second member 20B is shorter than the minor diameter of the discharge tube 10, and hence the recessed portion 21′ of either member may be deeper than that of the other member.

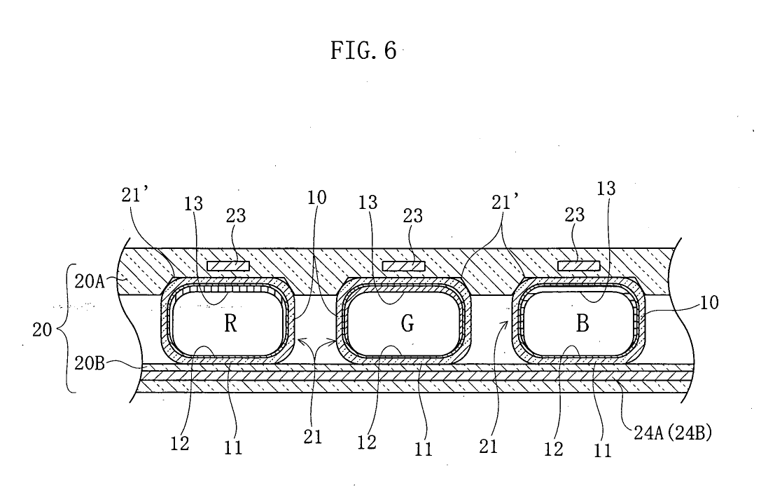

FIG. 6 is a fragmentary cross-sectional view of a discharge tube array according to a fifth embodiment. In the fifth embodiment, a side of the second member 20B to be in contact with the discharge tube 10 is made flat. Such discharge tube array allows more smoothly distributing the discharge tubes 10, because it suffices to position the discharge tubes 10 only with respect to the recessed portions 21′ of the first member 20A.

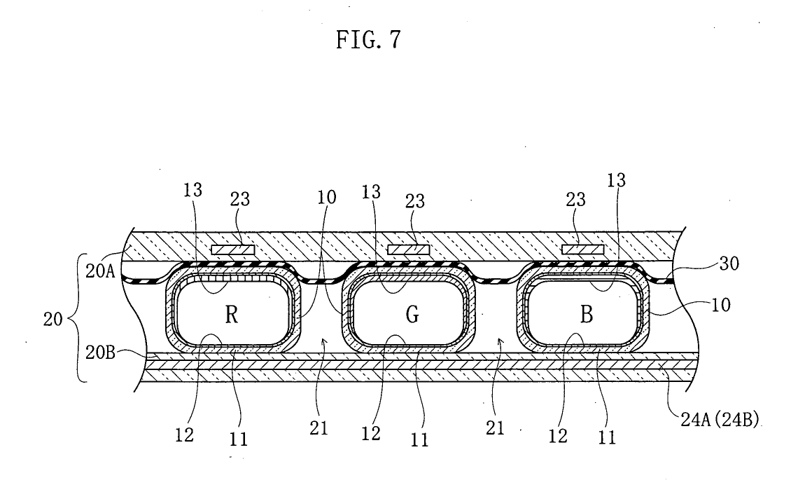

FIG. 7 is a fragmentary cross-sectional view of a discharge tube array according to a sixth embodiment. In the sixth embodiment, a side of the first member 20A and that of the second member 20B to be in contact with the discharge tube 10 are made flat, and to that side of the first member 20A, a corrugated plate-shaped auxiliary member 30 is attached, at positions corresponding to the address electrodes 23, for the positioning of the discharge tubes 10. The auxiliary member 30 is made of an insulative resin, and recessed portions for the discharge tubes 10 to be fitted in are brought close to the address electrodes 23, which is where the auxiliary member 30 is joined to the side of the first member 20A. Such discharge tube array allows not only smoothly distributing the discharge tubes 10, but also eliminates the need to form the recessed portions on the first member 20A and the second member 20B, thereby further simplifying the manufacturing process.

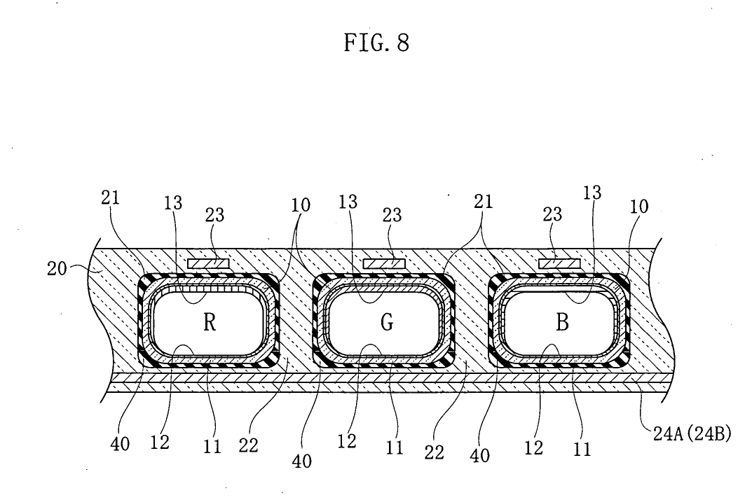

FIG. 8 is a fragmentary cross-sectional view of a discharge tube array according to a seventh embodiment. In the seventh embodiment, the hollow portion 21 is given an inner diameter that defines a relatively large gap with respect to the entire outer diameter of the discharge tube 10, and in the gap between the inner surface of the hollow portion 21 and the discharge tube 10 a liquid dielectric 40 of appropriate viscosity is loaded. Such discharge tube array allows more smoothly removing and inserting the from and into the hollow portion 21, because the dielectric 40 reduces friction between the discharge tube 10 and the inner surface of the hollow portion 21. Besides, employing a dielectric having a higher dielectric constant than air enables generating a stronger magnetic field inside the discharge tube 10 upon applying voltage to the hold electrode, scan electrode and address electrode, than in the case where the liquid dielectric is absent.

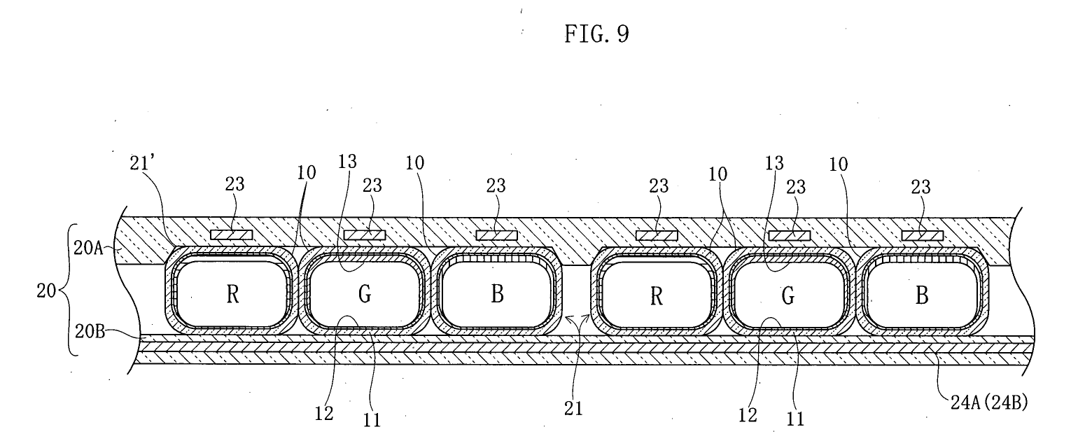

FIG. 9 is a fragmentary cross-sectional view of a discharge tube array according to an eighth embodiment. In the eighth embodiment, three discharge tubes 10 representing RGB thus constituting a pixel are grouped, and a multitude of recessed portions 21′ is formed so as to correspond to each such group, on a side of the first member 20A. The three discharge tubes 10 of RGB are aligned in contact with each other on the recessed portion 21′, and the address electrodes 23 are formed at positions corresponding to the discharge tubes 10 thus aligned. Such discharge tube array brings the three discharge tubes 10 of RGB constituting a pixel as close as possible to each other, thereby achieving higher resolution of the image composed of aggregation of a multitude of pixels.

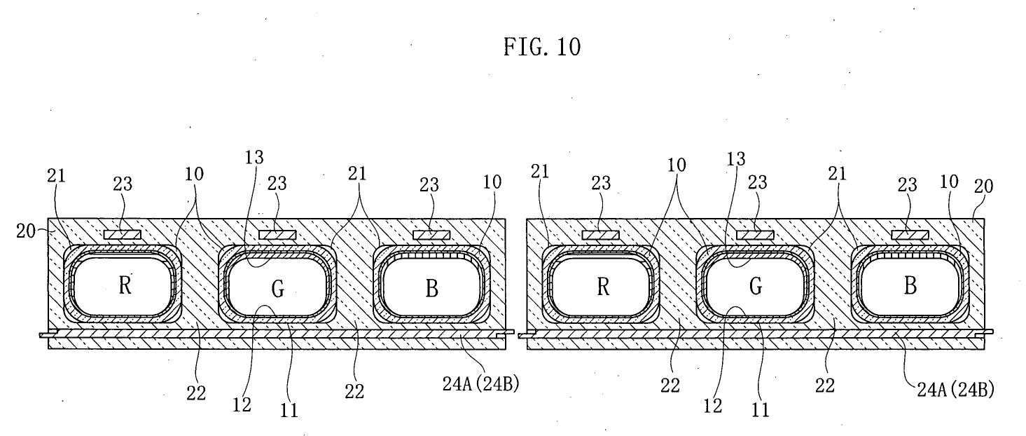

FIG. 10 is a fragmentary cross-sectional view of a discharge tube array according to a ninth embodiment. In the ninth embodiment, the holder 20 is divided so as to accommodate, for example, a group of three discharge tubes 10 of RGB, and such holders 20 are joined to each other. The display electrode pairs 24A, 24B are formed so as to be butt-connected at the joint portion of the holders 20. Such discharge tube array allows, in the manufacturing process, inserting and fixing the discharge tubes 10 in the hollow portion 21, with respect to each holder 20 separately prepared, thereby facilitating the handling of the holder 20 in the manufacturing process.

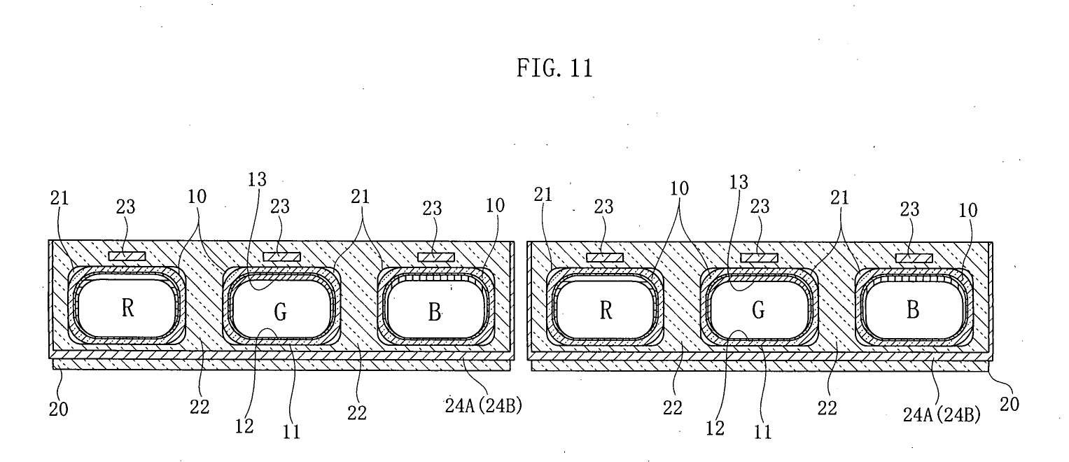

FIG. 11 is a fragmentary cross-sectional view of a discharge tube array according to a tenth embodiment. In the tenth embodiment also, the holder 20 is divided so as to accommodate a group of three discharge tubes 10 of RGB, and such holders 20 are joined to each other. End portions of the display electrode pair 24A, 24B are extended to lateral portions of the holder 20, so that the display electrode pairs 24A, 24B of the holders 20 to be joined are connected with the respective end portions opposing each other. Such discharge tube array also allows, in the manufacturing process, inserting and fixing the discharge tubes 10 in the hollow portion 21, with respect to each holder 20 separately prepared, thereby facilitating the handling of the holder 20.

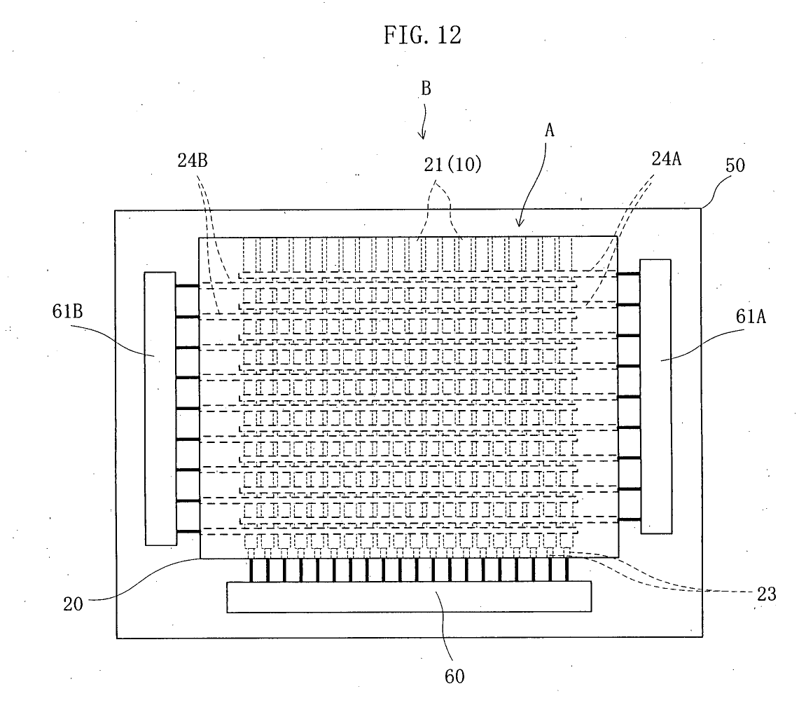

FIG. 12 is a front view showing a display device including a discharge tube array according to an eleventh embodiment. In the display device B, discharge tube array A is attached to a central portion of a substrate 50. At a lower portion of the substrate 50 below the discharge tube array A, an address electrode drive IC (first driving circuit) 60 is provided, for applying voltage to the address electrodes 23. In a right-hand portion of the substrate 50, at the right of the discharge tube array A when viewed from the front, a hold electrode drive IC (second driving circuit) 61A is provided, for applying voltage to the hold electrode 24A, and on a left-hand portion of the substrate 50, a scan electrode drive IC (second driving circuit) 61B is provided, for applying voltage to the scan electrode 24B. The address electrode drive IC 60, the hold electrode drive IC 61A, and the scan electrode drive IC 61B are connected to the address electrode 23, the hold electrode 24A, and the scan electrode 24B respectively, via a wiring pattern. Such display device B including the discharge tube array A allows properly applying desired voltages to the hold electrode 24A and the scan electrode 24B, because the hold electrode drive IC 61A and the scan electrode drive IC 61B are separately located on the right and left side of the discharge tube array A, thereby enabling achieving higher resolution of the image, by bringing the display electrode pair 24A, 24B as close as possible to each other.

1. A discharge tube array comprising:
a plurality of narrow discharge tubes each provided with an internal fluorescent layer; and
a holder formed with a hollow portion for holding the discharge tubes in a mutually parallel state, the discharge tubes being removably inserted into the hollow portion.

2. The discharge tube array according to claim 1, wherein the hollow portion includes a partition wall for dividing the discharge tubes into groups of a predetermined number.

3. The discharge tube array according to claim 1, wherein the hollow portion includes a corrugated plate-shaped auxiliary member for positioning the discharge tubes at a predetermined interval.

4. The discharge tube array according to claim 1, wherein the hollow portion is loaded with a liquid dielectric filling in a gap around the discharge tubes.

5. The discharge tube array according to claim 1, wherein the holder is separable into elements each for accommodating a predetermined unit number of the discharge tubes.

6. The discharge tube array according to claim 1, wherein the holder is provided with a plurality of first electrodes disposed along the discharge tubes, and with a plurality of second electrodes opposing the first electrodes across the hollow portion and extending in a direction intersecting with the first electrodes.

7. The discharge tube array according to claim 6, wherein the holder has a laminate structure comprising a first member having the first electrodes and a second member having the second electrodes.

8. A display device including a discharge tube array provided with a plurality of narrow discharge tubes each including an internal fluorescent layer, the device comprising:
a hollow portion for holding the discharge tubes in a mutually parallel state; a plurality of first electrodes disposed along the discharge tubes; a plurality of second electrodes opposing the first electrodes across the hollow portion and extending in a direction intersecting with the first electrodes; a holder for removably holding the discharge tubes in the hollow portion;
a first driving circuit for applying voltage to the first electrode; and
a second driving circuit for applying voltage to the second electrode.
